(19) United States
(12) Patent Application Publication
(10) Pub. No.: US 2007/0035954 A1
(43) Pub. Date: Feb. 15, 2007

(54) Device for detecting the dirt accumulation on a transparent covering pane in front of a optical unit

(76) Inventors: Holger Schanz, Lindau (DE); Wilfried Mehr, Bregenz (AT)

Correspondence Address: CONTINENTAL TEVES, INC., ONE CONTINENTAL DRIVE, AUBURN HILLLS, MI, 48326-1581, US

(21) Appl. No.: 10/578,153

(22) PCT Filed: Apr. 16, 2004
(86) PCT No.: PCT/DE04/00803

§ 371 Date: May 4, 2006

(30) Foreign Application Priority Data
Nov. 3, 2003 (DE) 103-51-254.3

(51) Int. Cl. B60Q 1/00

(52) U.S. Cl. 362/464; 362/276

(57) ABSTRACT

Disclosed is an environment detection system having two emitters of electromagnetic waves and two correspondingly directed receivers for receiving reflections of the emitted waves. The first emitter with a first receiver is directed towards a first target area and the second emitter with the second receiver is directed towards a second target area. In order to detect a third target area, an optical device is arranged at least in front of the first emitter. The optical device directs at least occasionally at least a proportion of the waves emitted by the emitter towards the third target area. An optical device is arranged at least in front of the second receiver, to direct at least occasionally reflections of the waves emitted by the first emitter towards the third target area towards the second receiver. The optical devices may be are arranged permanently and only one emitter is alternately active a time so that one receiver a time carries out an undisturbed detection of the third target area. This arrangement enables an emitter-receiver pair arranged on the right side of a motor vehicle and an emitter-receiver pair arranged on the left side of said motor vehicle to detect the whole front area in the direction of motion, wherein both emitter-receiver pairs are arranged in the direction of motion.

### BACKGROUND OF THE INVENTION

The invention relates to a device for detecting dirt accumulation on a transparent covering pane in front of an optical unit according to a device for detecting dirt accumulation on a transparent covering pane (1) in front of an optical unit (3,4).

Such devices are particularly required for environment monitoring systems that emit light and deduce information about the environment from the proportion of light reflected in the target area. In the future, such environment detection systems will be particularly employed in motor vehicles for seat occupancy recognition, longitudinal control, tracking, tracking error warning, or for taking measures in the event of an imminent crash. The detection of dirt accumulation enables the emitting power or sensitivity of reception to be adapted correspondingly and the received reflected proportion of light to be evaluated correctly.

Prior-art devices for detecting the degree of dirt accumulation are known from DE 196 46 078 and DE 197 04 793, for example. Said devices emit light vertically onto the covering pane that actually is transparent, wherein the increasing accumulation of dirt results in increased reflection. For detecting, the proportion reflected on the covering pane internally is measured and evaluated. This requires separate receiving units or a complicated process of distinguishing from reflections that occur outside the covering pane including the employment of correspondingly complicated devices. The prior-art devices are particularly unsuitable for an optical environment detection system having a swivelling emitter-receiver unit (i.e. in which the covering pane and the target area, in the end, are illuminated rather selectively a time), since it is not possible (or only possible with great efforts) to check a large area of the covering pane for dirt accumulation in this manner.

### SUMMARY OF THE INVENTION

The object of the invention is to provide an alternative device that enables the detection of dirt accumulation to be performed in a simple but precise manner and beyond the covering pane. This object is achieved by a device for detecting dirt accumulation on a transparent covering pane (1) in front of an optical unit (3,4). The device includes one or more elements (42) for coupling in light into the covering pane lengthwise at a predetermined coupling-in point in a predetermined direction and that the light passes through the covering pane (1) lengthwise (13); and an element (3) for detecting the proportion of light that reaches a predetermined light-decoupling point (32), wherein a degree of dirt accumulation is concluded from this proportion.

In prior art, the effect of reflection on the dirty interface between the covering pane and the environment is made use of. This is also done according to the invention. In contrast to prior art however, light is coupled into the pane lengthwise, i.e. laterally, wherein the covering pane is a large-surface but thin and transparent glass or plastic structure, wherein the side faces are arranged on the thin, circumferential edge, whereas the large-surface front/rear side is arranged between the emitter-receiver unit and the environment with the target area and is preferably arranged approximately vertically for this purpose. Thus, the covering pane approximately forms a plane within which light moves for the purpose of measuring the degree of dirt accumulation, wherein the thickness of the plane is negligible as against the longitudinal dimensions of the plane.

Just on account of dispersion, light is coupled into the covering pane in such a manner (also in case of lengthwise coupling) that reflections occur on the interfaces of the front/rear side. Again, the reflection coefficient depends on the degree of dirt accumulation so that only a certain proportion of light reaches the point of emergence due to multiple reflections over the length of the covering pane. Preferably, the coupling-in angle is chosen such that light impinges on the interfaces at an angle that does not lead to total reflection yet.

Preferably, light is deflected lengthwise at least once within the covering pane between the point of impingement and the point of emergence, i.e. there is a vertical or opposite course of light after deflection, for example, preferably an offset course through another part of the pane.

Such a device also allows a large-area measurement of the degree of dirt accumulation in optical environment detection systems including a swivelling emitter-receiver unit, in which the emitter-receiver unit can be directed towards the coupling-in and decoupling points, e.g. on the edge of the covering pane, by swivelling which means that the emitting and receiving directions extend towards said edge and that, in this swivelling position, the proportion of light that has run lengthwise through the pane is detected instead of the reflections from the target area.

### BRIEF DESCRIPTION OF THE DRAWINGS

The invention will now be explained in greater detail on the basis of exemplary embodiments and figures.

Brief Description of the Figures:

FIG. 1 Device for detecting dirt accumulation on a transparent covering pane in front
a. of an optical unit;

FIG. 2 Sectional view referring to FIG. 1;

FIG. 3 Points of coupling-in and decoupling as well as course of light lengthwise
a. through the pane;

FIG. 4 Course of light within the pane when deflected;

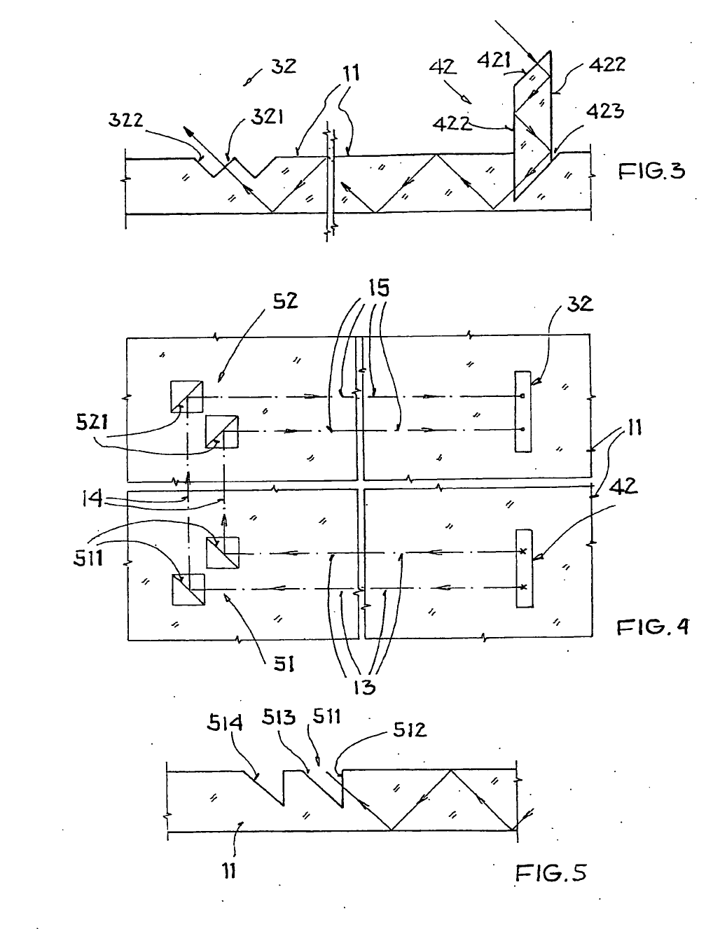

FIG. 5 Trench structure within the pane for forming an optical interface as a deflecting
a. means.

### DETAILED DESCRIPTION OF THE DRAWINGS

FIG. 1 is a sketch of a device for detecting dirt accumulation on a transparent covering pane of an optical unit illustrated by an environment detection system as may be used in a motor vehicle, for example.

There are means 42 for coupling in light that couple light into the covering pane lengthwise at a predetermined coupling-in point in a predetermined direction whereafter the light passes through the covering pane 1 lengthwise (see course of light beam 13). FIG. 3 shows a possible realization of said coupling-in means in detail. There is a coupling-in stud 42 comprising an impingement face 421, said face 421 being inclined in such a manner that the light beam impinges on it approximately vertically. The side faces 422 of the stud act as guide surfaces that comprise a relatively high proportion of reflection, preferably total reflection of incident light, and lead light into the pane, wherein at least a proportion of light that is not insignificant is coupled into the covering pane lengthwise. A trench 423 additionally forms an interface directing light in the desired direction. For this purpose, the trench comprises a side face that is arranged approximately parallel to the coupling-in stud, said side face forming an optical interface with a medium that comprises a different refractive index, e.g. air, said interface thus comprising at least a high degree of light reflectance on account of its angle relative to the light. Then, the light coupled in passes through the pane 1 lengthwise as illustrated in the figures, wherein only a rough orientation is required and a plane-parallel orientation relative to the covering pane is particularly unnecessary or undesirable. In fact, it is desired to achieve reflections on both interfaces of the covering pane 1 with the ambient air and thus also towards the potentially dirty region, wherein the angle at which the light beams impinge on said interfaces is preferably chosen such that only a partial reflection is achieved. Thus, reflectance on the transparent cover depends on the degree of dirt accumulation on the covering pane 1 which means that reflectance will increase when the degree of dirt accumulation increases, wherein there is no linear progression.

The light passing through the pane 1 lengthwise is reflected partially and several times also on the outer interface of the covering pane 1 (said outer interface being susceptible to dirt accumulation) so that the dependence on dirt accumulation multiplies as against conventional vertical exposure of the pane to light and simple reflection and also covers the pane over its full length.

Moreover, there are means 3 for detecting the proportion of light reaching a predetermined light-decoupling point 32. According to FIG. 3, said light-decoupling point 32 is realized in the form of trenches that comprise interfaces arranged at an angle of about 45 degrees so that reflections on this interface are as small as possible, thereby being able to reach a high degree of decoupling.

The fact that the illustrated device is characterized in that light passes through the covering pane lengthwise and more or less parallel to the plane of the pane enables means 51, 52 for deflecting the coupled-in light to be provided on the side opposite the side of the point where light is coupled in, i.e. opposite in the lengthwise direction of the covering pane 1, said means 51, 52 deflecting the light at least once towards the point of decoupling. The means 51, 52 for deflecting the light coupled into the covering pane lengthwise are configured in such a manner that light passes through the covering pane lengthwise at least twice on different courses 13, 15. This means that light can be deflected within the covering pane several times and that the dependence on dirt accumulation can thus be increased. Moreover, it is easily possible to cover the covering pane completely. The sketch of FIG. 5 shows that the deflecting means 51, 52 can also be realized in the form of trench structures with optical interfaces, wherein in this realization the interface 512 is arranged again vertically to the covering pane 1 for the purpose of achieving high reflectance.

For deflecting light towards another region of the covering pane 1, the trench comprises a non-vertical angle relative to the previous direction of light propagation within the covering pane 1. In particular, the trenches are arranged at angles of 45 degrees in our exemplary embodiment (see FIG. 1 and FIG. 5) so that the light passes through the covering pane for a second time, wherein the course of light comprises an approximately parallel offset. Of course, the light may be deflected more often than indicated herein.

The means for coupling-in, decoupling and deflecting illustrated herein are examples only and can be integrated into the covering pane in a relatively simple manner.

The use of deflection also enables both the point of coupling-in 42 and the point of decoupling 32 to be arranged on one side of the covering pane 1, said side being arranged approximately vertically to the lengthwise direction of the covering pane 1. This is important for systems comprising a swivelling emitter-receiver unit as explained with reference to the exemplary embodiment below.

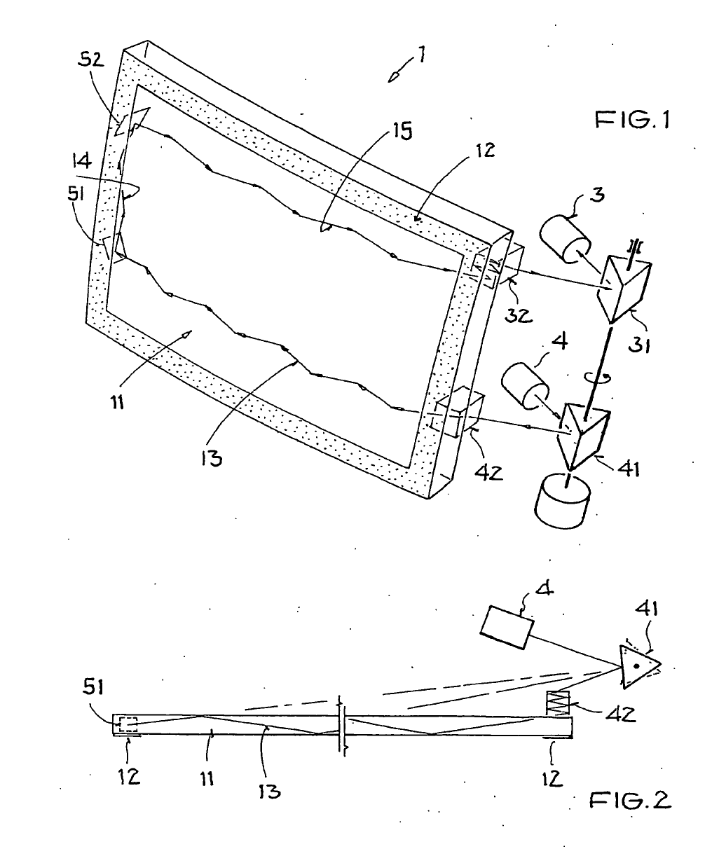

The optical environment detection system according to FIG. 1 and FIG. 2 comprises a swivelling emitter-receiver unit 3, 4 that emits an emitter light-induced pulse towards a predetermined target area and detects and evaluates the impulse response. In addition to systems with a directly swivelling emitter-receiver unit 3, 4 there are also systems that use swivelling optical deflecting means, e.g. rotating prisms, as indicated in FIG. 1 and FIG. 2. All such systems illuminate and detect only a particular part of the whole target area per unit of time. It would take such systems a very long time to cover the complete pane if they measured the accumulation of dirt in the conventional manner, i.e. by vertical light incidence on the pane and measuring reflection, since the system would have to scan the pane step by step over its full length as performed by the system for detecting the target area.

Therefore, a device is provided in which the emitter-receiver unit 3, 4 or the deflecting means 31, 41 can swivel into a predetermined position where the points of coupling-in and decoupling 32, 42 are arranged. The emitter unit 4 emits a light-induced pulse to the point of coupling-in 42 and the receiver unit 3 detects the proportion that reaches the point of decoupling 32. The degree of dirt accumulation is concluded from this incoming proportion of the light-induced pulse.

Preferably, the points of coupling-in and decoupling 32, 42 are arranged on the edge 12 of the covering pane 1 and the edge 12 of the covering pane 1 is covered towards the target area by an opaque cover (see FIG. 1 and FIG. 2). That means that the emitter-receiver unit 3, 4 or its deflecting means 31, 41 swivel to an edge portion so that the accumulation of dirt is measured in this swivelling position.

1-7. (canceled)

8. A device for detecting dirt accumulation on a transparent covering pane (1) in front of an optical unit (3,4), the device comprising:
one or more elements (42) for coupling in light into the covering pane lengthwise at a predetermined coupling-in point in a predetermined direction and that the light passes through the covering pane (1) lengthwise (13); and
an element (3) for detecting the proportion of light that reaches a predetermined light-decoupling point (32), wherein a degree of dirt accumulation is concluded from this proportion.

9. A device according to claim 8, further comprising one or more elements (51, 52) for deflecting the coupled-in light are provided on a side opposite a side of the point where light is coupled in, i.e. opposite in the lengthwise direction of the covering pane (11), wherein the one more elements for deflecting the coupled light (51, 52) deflect the light at least once towards the point of decoupling.

10. A device according to claim 9, wherein the one or more elements (51, 52) for deflecting the light coupled into the covering pane lengthwise are configured in such a manner that the light passes through the covering pane lengthwise (13, 15) at least twice on different courses.

11. A device according to claim 8, wherein both the point of coupling-in and the point of decoupling are arranged on one side of the covering pane (11), the side being arranged approximately vertically to the lengthwise direction of the covering pane.

12. An optical environment detection system comprising:
an emitter-receiver unit (3, 4) that emits an emitter light-induced pulse towards a predetermined target area and detects and evaluates the impulse response;
a transparent covering, wherein the emitter-receiver unit (3, 4) is arranged behind the transparent covering pane (11) and both the emitter light-induced pulse and the detected target area are swivellable (31, 41);
a device having one or more elements (42) for coupling in light into the covering pane lengthwise at a predetermined coupling-in point in a predetermined direction and that the light passes through the covering pane (1) lengthwise (13), and an element (3) for detecting the proportion of light that reaches a predetermined light-decoupling point (32), and the points of coupling-in and decoupling (32, 42) are arranged in a predetermined swivelling position and that in this swivelling position the emitter unit (4) emits a light-induced pulse to the point of coupling-in (42) and the receiver unit (3) detects the proportion that reaches the point of decoupling (32) and that a degree of dirt accumulation is concluded from this proportion.

13. A system according to claim 12, wherein points of coupling-in and decoupling (32, 42) are arranged on an edge (12) of the covering pane (11) and the edge (12) of the covering pane (11) is covered towards a target area (12) by an opaque cover.

14. A system according to claim 12, wherein the system is provided in a motor vehicle.
